(19) United States
(12) Patent Application Publication
(10) Pub. No.: US 2025/0269343 A1
(43) Pub. Date: Aug. 28, 2025

(54) Non-Homogenous Thermocatalytic Gaseous Reactor

(71) Applicant: Michael Gurin, Glenview, IL (US)

(72) Inventor: Michael Gurin, Glenview, IL (US)

(21) Appl. No.: 19/200,644

(22) Filed: May 6, 2025

Related U.S. Application Data
(63) Continuation-in-part of application No. 18/398,108, filed on Dec. 27, 2023.

(51) Int. Cl. B01J 8/18; B01J 8/26

(52) U.S. Cl. CPC B01J 8/1836; B01J 8/1809; B01J 8/26; B01J 2208/00504; B01J 2208/00548; B01J 2208/00654; B01J 2208/00769

(57) ABSTRACT

A non-homogeneous thermocatalytic gaseous reactor consists of an unreacted gaseous reactant, an interior shell, an active catalyst with a minimum and maximum active temperature threshold, and active unreacted gaseous reactant flow regulator thresholds. It also includes a real-time unreacted gaseous reactant flow regulator and a real-time unreacted gaseous reactant inlet temperature into the reactor.

### CROSS-REFERENCE TO RELATED APPLICATIONS

This application claims the priority benefit as a continuation in part from U.S. patent application Ser. No. 18/398,108 titled “Ultra-High Efficiency Hydrogen Hybrid Regenerative Thermodynamic System” on Dec. 27, 2023, the content of which is incorporated by reference.

### BACKGROUND

The field of the invention relates to catalytic reactors, which are systems designed to facilitate chemical reactions between reactants in the presence of a catalyst. These reactors are crucial in various industrial processes, including the production of fuels, chemicals, and pharmaceuticals. The development of catalytic reactors has been a significant area of research, with a focus on improving reaction efficiency, selectivity, and stability.

Fluidized bed catalytic reactors are a common type of catalytic reactor, where a bed of catalyst is fluidized by a gas stream to enhance mass and heat transfer. While fluidized bed reactors offer several advantages, they can also exhibit limitations in maintaining a uniform reaction environment. In particular, the fluidized bed can become homogenized, leading to a uniform reaction domain. However, this homogeneity can also limit the reactor's ability to exploit the inherent non-homogeneity of the reactants and catalysts, potentially hindering reaction performance and product quality.

The homogeneity of the fluidized bed can also make it challenging to achieve the desired reaction conditions, such as temperature gradients and localized reaction zones. Furthermore, the use of fluidized bed reactors can be limited by the need for precise control over gas flow rates, catalyst loading, and reaction conditions.

A significant challenge in managing these reactors is the regulation of unreacted gaseous reactants. This is crucial for maintaining the catalyst's effectiveness and preventing the formation of unwanted by-products that can foul the non-homogenous thermocatalytic gaseous reactor. The reactor's control system must also accurately measure and adjust the flow of unreacted gases to ensure that the catalyst operates within its optimal temperature and pressure range within an area of the non-homogenous thermocatalytic gaseous reactor less susceptible to fouling. This is essential for sustaining the catalyst's activity and extending its operational lifespan.

To tackle this issue, non-homogenous thermocatalytic gaseous reactors are equipped with advanced flow control mechanisms. These include sensors and actuators that continuously monitor the composition, temperature, and pressure of the incoming gases. Based on this real-time data, the flow control system dynamically adjusts the feed rates of reactants to match the reactor's demand. This precise regulation ensures that the catalyst is consistently exposed to the ideal reaction conditions, leading to higher conversion rates, improved product yield, and enhanced selectivity in the chemical reactions taking place all with minimal fouling of the non-homogenous thermocatalytic gaseous reactor.

It is therefore an objective of the present disclosure to overcome the above limitations at least in part, by enabling catalytic reactions in a fluidized bed to maintain a non-homogeneous reaction domain, thereby improving reaction efficiency, selectivity, and product quality. Non-homogenous thermocatalytic gaseous reactors are a class of advanced reactor systems tailored for the conversion of gaseous reactants into desired products through catalysis.

### BRIEF SUMMARY

In various embodiments, a non-homogenous thermocatalytic gaseous reactor can be constructed with an unreacted gaseous reactant. The reactor includes an interior shell and an active catalyst that operates between a minimum and maximum active temperature threshold. The reactor also incorporates a flow regulator that adjusts the flow of unreacted gaseous reactant, with minimum and maximum flow regulator thresholds. Additionally, the reactor features real-time monitoring and regulation of the unreacted gaseous reactant flow and the inlet temperature of the unreacted gaseous reactant entering the reactor.

In some embodiments, the non-homogenous thermocatalytic gaseous reactor comprises an unreacted gaseous reactant, an interior shell, an active catalyst that maintains an active temperature between a minimum and maximum threshold, a minimum and maximum unreacted gaseous reactant flow regulator threshold, a real-time unreacted gaseous reactant flow regulator, and a real-time measurement of the unreacted gaseous reactant inlet temperature into the reactor.

In some embodiments, the non-homogenous thermocatalytic gaseous reactor comprises an unreacted gaseous reactant, an interior shell, an active catalyst with an operational temperature range between a minimum and maximum threshold, a minimum and maximum unreacted gaseous reactant flow rate regulator threshold, a real-time regulator for the unreacted gaseous reactant flow, and a real-time inlet temperature measurement for the unreacted gaseous reactant entering the reactor.

The term non-homogenous refers to the uneven distribution of catalyst within the reactor though in this invention utilizing intentionally non-homogenous flows to achieve optimal results by the integral active catalyst within the non-homogenous thermocatalytic gaseous reactor, which again intentionally leads to the formation of distinct zones with varied catalytic properties and reaction conditions.

### TERMS AND DEFINITIONS

“Active catalyst” refers to a material that accelerates chemical reactions, typically used to facilitate the conversion of reactants into products in a controlled environment, such as a thermocatalytic gaseous reactor.

“Active catalyst mode” refers to operational mode of a non-homogeneous thermocatalytic gaseous reactor where the catalyst is active, allowing the conversion of the gaseous reactant, and the temperature of the catalyst is within its specified range (minimum and maximum threshold temperatures).

“Active catalyst parameter set” refers to a minimum set of individual parameters for regulating control of non-homogenous thermocatalytic gaseous reactor included by the control system as a function of real-time operating conditions consisting of minimum active temperature threshold, maximum active temperature threshold, minimum active unreacted gaseous reactant flow regulator threshold, maximum active unreacted gaseous reactant flow regulator threshold, and active catalyst mode.

“Array” refers to a set of discrete elements, each corresponding to a particular individual (i.e., module) non-homogenous thermocatalytic gaseous reactor. The non-homogenous thermocatalytic gaseous reactor within the array can be any combination of non-homogenous thermocatalytic gaseous reactor or non-homogenous thermocatalytic gaseous reactors in parallel flow configuration or series flow configuration with each other. The individual non-homogenous thermocatalytic gaseous reactor is optimally configured such that each non-homogenous thermocatalytic gaseous reactor or set of non-homogenous thermocatalytic gaseous reactors can be bypassed or isolated from another non-homogenous thermocatalytic gaseous reactor or set of non-homogenous thermocatalytic gaseous reactors.

“Back-flow direction” refers to the direction of gas flow preferably of a flow inlet port closer to the interior shell of the non-homogenous thermocatalytic gaseous reactor relative to a further inward forward direction of a second flow inlet port into again a further inward portion of the non-homogenous thermocatalytic gaseous reactor.

“Back-flow velocity” refers to the speed at which unreacted gaseous reactant flows backward into the reactor mode typically measured in units of velocity, often in m/s or ft/s.

“Bellow” refers to a flexible or elastic vessel in the context of this invention when the bellow is in its most compressed position it achieves the minimum reactor volume and in its most expanded position it achieves the maximum reactor volume. One embodiment of the bellow is a twisted bellow relative to a non-twisted bellow has the benefit of reducing turbulence for any unreacted gaseous reactant flowing over the bellow itself particularly when the bellow itself has the interior-facing side of the bellow being the interior shell of the non-homogenous thermocatalytic gaseous reactor.

“Carbon dioxide combustion product” refers to a gas (CO2) that is a product of the thermal decomposition or combustion of a fuel or reactant typically resulting from the reaction of carbon-containing compounds such as unreacted gaseous reactant that initially contains carbon. In this instance the combustion takes place downstream of the non-homogenous thermocatalytic gaseous reactor.

“Catalyst discharge mode” refers to a control mode for discharging of the initially active catalyst (typically then in an at least reduced state of activity or in fact a spent catalyst). The discharged catalyst is preferably utilized for a next process downstream of the non-homogenous thermocatalytic gaseous reactor or to prepare the catalyst for regeneration.

“Catalyst fill mode” refers to the reactor mode where control of the amount of catalyst material is filled into the non-homogenous thermocatalytic gaseous reactor, preferably adjusted to optimize the reaction process in creation of solid reacted product or reacted liquid product.

“Catalyst transition mode” refers to a state or condition in a thermocatalytic gaseous reactor where the active catalyst's temperature falls outside of its minimum and maximum thresholds or the active catalyst's real-time flow rate falls outside of its minimum and maximum thresholds in preparation of the non-homogenous thermocatalytic gaseous reactor changing from a first reactor mode to a second reactor mode.

“Catalytic reactivity ratio” refers to the ratio of the rates of reaction of a catalyst with different reactants. One instance is the ratio of hydrogen to carbon on a mass basis for unreacted gaseous reactants at the inlet cross section. Another instance is the ratio of hydrogen to carbon on a mass basis at the discharge cross section. This comparison of two instances provides a basis to compare the activity of the active catalyst within the non-homogenous thermocatalytic gaseous reactor.

“Combustor” refers to a device in which combustion takes place (i.e., typically oxidation reaction) creating thermal energy by an exothermic reaction. In this invention the combustor is downstream of the non-homogenous thermocatalytic gaseous reactor where any desired combination of unreacted gaseous reactant, reacted gaseous product, or a dedicated fuel from a fuel storage tank is combusted within the reactor.

“Control system” refers to a set of mechanisms and algorithms that monitor and adjust the reactor's operating parameters in real-time to optimize the thermocatalytic reaction, including the flow rates and temperatures of the reactants, the catalyst, and the interior and exterior environments. The control system is understood to be capable of monitoring and/or adjusting processes upstream and/or downstream of the non-homogenous thermocatalytic gaseous reactor including where active catalyst is sourced or discharged, fuel including liquid fuel is stored or consumed, gaseous hydrogen is stored, discharged or consumed, gaseous methane is stored, discharged or consumed, or solid reacted product is stored, discharged or transported.

“Conversion ratio” refers to the ratio of unreacted gaseous reactant to aggregate of reacted gaseous products, reacted liquid products, and solid reacted products on a mass basis.

“Convex sector” refers to sector of the interior-facing side of the interior shell that has a convex shape, such that the exterior-facing side of the interior shell has a concave shape.

“Discharge cross section” refers to In the context of a thermocatalytic gaseous reactor, a “discharge cross section” refers to a measurement or a characteristic of the discharging flow post active catalyst reactivity that is being controlled or regulated in real-time, typically through a valve or a flow regulator at a discharge point downstream (at least relative to the inlet cross section) of the non-homogenous thermocatalytic gaseous reactor.

“Downstream combustor sensor” refers to a sensor that monitors at least the temperature and preferably also material composition post-combustion (ideally providing determination of combustion products such as water or water vapor “H₂O” and carbon dioxide combustion product “CO2”) of the unreacted gaseous reactant flowing out of the reactor, typically used for real-time control and optimization of the thermocatalytic gas reactor's operating conditions. In a preferred instance of the non-homogenous thermocatalytic gaseous reactor the unreacted gaseous reactant is reacted over the active catalyst to sequester carbon as a solid reacted product. In many instances it is impossible or too costly to determine real-time operating conditions of the reacted gaseous product and therefore the downstream combustor sensor provides a lagging indicator of the actual (though not measured directly) catalytic reactivity ratio as post-combustion production of water is relatively easy to determine as known in the art including taking a slipstream of combustion exhaust that is condensed or compressed so as to measure mass of water as a condensed liquid.

“Emissions profile” refers to a graphical representation of the concentrations of various species, such as gases or particles, emitted by the reactor as a function of multiple parameters including active catalyst on-stream time, real-time flow rate or real-time temperature etc., particularly downstream of the combustor. As noted, the downstream combustor sensor purpose includes providing an emissions profile resulting from combustion of the unreacted gaseous reactant within the combustor.

“Expander” refers to a mechanical device as known in the art to include an expansion valve, a turboexpander or virtually any device to decrease the pressure of the unreacted gaseous reactant (in this invention) such that thermodynamically the temperature of the unreacted gaseous reactant is lowered via expansion cooling. It is typical for unreacted gaseous reactant, when the reactant is gaseous methane, to be stored or delivered at a higher pressure than the pressure at which the unreacted gaseous reactant enters into the non-homogenous thermocatalytic gaseous reactor.

“Exterior-facing side” refers to the opposite surface of the interior-facing side of the non-homogenous thermocatalytic gaseous reactor, notably the side of the interior shell that doesn't get exposed to any active catalyst.

“Feedback command” refers to an instruction that controls the flow of unreacted gaseous reactant into the reactor based on real-time data, such as temperature or flow rate, to maintain optimal operating conditions though prior to adjustment by the feedforward command.

“Feedback comparator” refers to a control component that compares the current state of a controlled parameter from the reactor point parameter set with a predetermined setpoint, and adjusts the regulator in accordance to the feedback command adjusted by the feedforward command.

“Feedback error” refers to a control action taken by the system to correct the difference between the desired and actual process conditions.

“Feedback loop” refers to a control mechanism that uses the output of the process or system to provide input to the same system, in order to regulate, stabilize, or correct its behavior, in this case, based on the feedback error.

“Feedback module” refers to a standard feedback loop that monitors and adjusts the process variables, such as unreacted gaseous reactant flow rate or inlet temperature, in real-time to optimize the performance and efficiency of the thermocatalytic gaseous reactor.

“Feedforward and feedback loop control system” refers to the combination of controlling components (i.e., energy storage components and energy distribution lines) first using a feedforward control system immediately followed by a feedback control system such that control parameters of the feedback control system are a function of the feedforward control system. For clarity, it is understood that the term control system is at least a feedback loop control system and preferably a feedforward and feedback loop control system.

“Feedforward command” refers to an instruction that controls the flow of unreacted gaseous reactant into the reactor based on real-time data, such as temperature or flow rate, to maintain optimal operating conditions modifying the adjustment beyond by the feedback command.

“Feedforward comparator” refers to a control component that compares the current state of a controlled parameter from the reactor point parameter set with a predetermined setpoint and feedforward inputs.

“Feedforward control system” refers to a control system that uses real-time measurements of the process variables to adjust the inputs to the process in order to maintain desired output, without relying on feedback from the process itself. In this context, it's a system that uses real-time regulators to control the flow of unreacted gaseous reactant into the reactor. Furthermore, it is a type of control system that takes preemptive action based on known or anticipated disturbances to improve system performance. It operates by directly manipulating the system's input using a model or prediction of how disturbances will impact the output, rather than reacting to the system's output after it has been affected.

“Feedforward inputs” refers to parameters or settings that directly influence the operational conditions of a system, such as the real-time unreacted gaseous reactant flow regulator and the real-time unreacted gaseous reactant inlet temperature, which are used to control the reactor's operation in real-time yet looking proactively and not simply based on inputs of a typical feedback module.

“Feedforward modified command” refers to a control signal that is sent directly to the process or system being controlled, without going through a feedback loop, to modify the command or action being taken. In the context of the thermocatalytic reactor, it would refer to a control signal that could directly modifies the flow rate or temperature of the unreacted gaseous reactant.

“Feedforward module” refers to the feedforward and feedback loop control system that specifically addresses proactive modifications beyond a traditional feedback loop.

“Feedforward outputs” refers to parameters that regulate the flow rate of an unreacted gaseous reactant into the reactor based on the current temperature of the active catalyst and the unreacted gaseous reactant flowing out of the reactor, to maintain a desired reaction condition based on the combination of feedback command and adjustments made by executing the feedforward command.

“Flow discharge port” refers to a passage in which any medium discharges from the non-homogenous thermocatalytic gaseous reactor including unreacted gaseous reactant, for example allowing for a degree of regulation of the reactant flow rate via back-pressure.

“Flow diverter” refers to mechanical part that changes the flow of any unreacted gaseous reactant, reacted gaseous product, or stream of residual gases from a current flow vector to a subsequent flow vector that is different than the current flow vector.

“Flow inlet port” refers to an interface through which an unreacted gaseous reactant (or any input that enters into the non-homogenous thermocatalytic gaseous reactor upstream of interaction with the active catalyst) is introduced into the non-homogeneous thermocatalytic gaseous reactor, providing the inlet flow of unreacted gaseous reactant that enters the reactor.

“Flow regulator” refers to a device or system that controls the flow rate of a fluid, such as a gas or liquid, into or out of a system, in this case, a thermocatalytic gaseous reactor. The flow regulator as known in the art can regulate flow by changing an aperture into the flow inlet port or back-pressure out of a flow discharge port of the non-homogenous thermocatalytic gaseous reactor.

“Forward direction” refers to the primary direction of flow into the non-homogenous thermocatalytic gaseous reactor, as compared to the back-flow direction (such that a portion of any medium having a back-flow direction and a back-flow velocity will reduce forward flow velocity of any mixing with flow having a forward direction and forward flow velocity.

“Forward flow velocity” refers to the speed at which unreacted gaseous reactant flows forward into the non-homogenous thermocatalytic gaseous reactor typically measured in units of velocity, often in m/s or ft/s, of a medium having a forward direction relative to the non-homogenous thermocatalytic gaseous reactor.

“Fouling” refers to deposition of substances, such as chemicals or solid reacted product materials, on the surface of equipment or catalysts within the reactor, which can reduce its efficiency and effectiveness over time in this instance if the non-homogenous thermocatalytic gaseous real-time reactor volume is not adjusted by the control system (and preferably by the feedforward control system).

“Fuel” refers any combustible medium, in this instance preferably that reacts with unreacted gaseous reactant or reacted gaseous product within the combustor.

“Fuel storage tank” refers to any storage device as known in the art such that the flow of fuel is independent of a fuel delivery by means also known in the art.

“Functionality modes” refers to specific operational states or regimes of the reactor, which are dynamically controlled in real-time to optimize the conversion of the unreacted gaseous reactant, based on parameters such as reactant flow rates and inlet temperatures. Most importantly the control system varies the aggregate of modes in which the non-homogenous thermocatalytic gaseous reactor operates including the reactor modes of active catalyst mode, non-reactive catalyst mode, catalyst discharge mode, catalyst fill mode, catalyst transition mode, and standby catalyst mode.

“Gaseous fluid communications” refers to the transfer of any gaseous medium from a first portion of any component within the non-homogenous thermocatalytic gaseous reactor (including upstream or downstream components) preferably by controlling at least one flow regulator, in a manner that enables efficient and controlled gas phase interactions.

“Gaseous hydrogen” refers to a component of a mixture having the presence of hydrogen in its molecular form.

“Gaseous methane” refers to methane (CH4), a hydrocarbon gas, specifically a simple and common gaseous reactant in various chemical processes. Methane is used interchangeably as known in the art as natural gas which includes renewable natural gas as derived by biological processes notably anaerobic digestion.

“Heat exchanger” refers to any device in which thermal energy is transferred between two mediums, which can include air-to-air (a.k.a., gaseous as opposed to liquid or solid), liquid-to-air, or liquid-to-liquid.

“High temperature waste heat” refers to heat energy generated by any means, though preferably by combustion in the combustor, such that excess thermal energy (notably for power generation or driving an endothermic reaction) is not useful in the respective primary purpose of combustion. In particular a simple cycle power generation cycle has significant waste heat that easily exceeds the minimum active temperature threshold of the active catalyst. The higher temperature enables reactions to take place without the presence of an active catalyst (which typically lowers the minimum active temperature threshold in which catalytic chemical reactions take place).

“Hydrogen storage tank” refers to any storage device as known in the art such that the flow of hydrogen is independent of a hydrogen delivery by means also known in the art.

“Inlet cross section” refers to the geometric cross-sectional area of the main flow channel through which the unreacted gaseous reactant enters the non-homogenous thermocatalytic gaseous reactor.

“Inlet temperature” refers to the temperature at which any medium enters the non-homogenous thermocatalytic gaseous reactor at the flow inlet port (or anywhere upstream of interacting with the active catalyst).

“Integral bellow actuator” refers to the integral reactor actuator when the non-homogenous thermocatalytic gaseous reactor interior shell is at least in part made of a bellow.

“Integral reactor actuator” refers to the mechanical device operable to vary the real-time reactor volume between the minimum reactor volume and the maximum reactor volume by varying respectively between the minimum reactor position and the maximum reactor position.

“Interior shell” refers to the hollow or enclosed space within a non-homogeneous thermocatalytic gaseous reactor, which can contain the unreacted gaseous reactant.

“Interior-facing side” refers to the side of the interior shell of the thermocatalytic gaseous reactor that faces the unreacted gaseous reactant.

“Liquid fuel” refers to a liquid that is used as a fuel, typically in a thermocatalytic gaseous reactor, but in this context, explicitly differentiating from a gaseous combustible medium. Based on common usage, a liquid fuel refers to a liquid hydrocarbon or other combustible fluid that is burned by the combustor to produce energy (i.e., an exothermic reaction).

“Location” refers to a physical position in which the non-homogenous thermocatalytic gaseous reactor is located at a specific point in time. An instance of the non-homogenous thermocatalytic gaseous reactor, given its modularity and ability to be appropriately sized for portability and/or on-vehicle mobility, is such that methane flows over the active catalyst within the non-homogenous thermocatalytic gaseous reactor in order to provide on-demand gaseous hydrogen for combustion within the on-vehicle combustor or other as known in the art hydrogen consuming energy production device for movement of the vehicle from a first location to a second location. Another instance is a logistics vehicle moves the non-homogenous thermocatalytic gaseous reactor from a first location to a second location such that on-demand gaseous hydrogen yields on-site though stationary thermal energy or electricity at the second location.

“Maximum active temperature threshold” refers to the highest temperature at which the catalyst is able to maintain its catalytic activity, at least in which the catalytic reactivity ratio is predominantly maintained (i.e., not accelerated into a non-reactive catalytic condition that would accelerate the time in which the non-homogenous thermocatalytic gaseous reactor would have to enter into a non-reactive catalyst mode).

“Maximum active unreacted gaseous reactant flow regulator threshold” refers to the highest rate at which unreacted gaseous reactant can flow into the reactor while maintaining the active temperature of the catalyst within its specified minimum and maximum temperature thresholds, or at which unreacted gaseous reactant can flow into the reactor while maintaining the real-time flow rate within its specified minimum active unreacted gaseous reactant flow regulator threshold and maximum active unreacted gaseous reactant flow regulator thresholds.

“Maximum reactor position” refers to the operating point or setpoint within the non-homogenous thermocatalytic gaseous reactor at which the maximum reactor volume is obtained by regulating an actuator for real-time reactor volume increase until the maximum reactor volume is realized.

“Maximum reactor volume” refers to the highest actual volume of the non-homogenous thermocatalytic gaseous reactor.

“Meta sensor” refers to a calculated function that is typically calibrated or measured on a previous set of data preferably utilizing machine learning to prevent the necessity for expensive or impossible to determine from direct measurement of actual flow rates. It is understood that a meta sensor can be used for any physical parameter whether it be a ratio, a real-time flow rate, a real-time temperature, a real-time reactor volume, etc. In fact, the actual term of a real-time parametric value can interchangeably be a calculated and projected value as determined by a minimum viable set of operating conditions in which prior training has taken place.

“Minimum active temperature threshold” refers to the lowest temperature at which the catalyst is able to maintain its catalytic activity typically for a specific real-time flow rate in which the non-homogenous thermocatalytic gaseous reactor would have to remain in the active catalyst mode.

“Minimum active unreacted gaseous reactant flow regulator threshold” refers to lowest real-time flow rate at which the catalyst is able to maintain its catalytic activity typically for a specific real-time temperature in which the non-homogenous thermocatalytic gaseous reactor would have to remain in the active catalyst mode.

“Minimum reactor position” refers to the operating point or setpoint within the non-homogenous thermocatalytic gaseous reactor at which the minimum reactor volume is obtained by regulating an actuator for real-time reactor volume decrease until the minimum reactor volume is realized (i.e., when the non-homogenous thermocatalytic gaseous reactor is in the catalyst fill mode, or at the conclusion of the catalyst discharge mode).

“Minimum reactor volume” refers to the lowest actual volume of the non-homogenous thermocatalytic gaseous reactor.

“Non-homogenous thermocatalytic gaseous reactor” refers to a type of reactor that has varying concentrations of reactants, catalyst, or temperatures within its volume, resulting in a non-uniform reaction process. The intentional and inventive to have unreacted gaseous reactant or any unreacted medium flow through the inlet cross section in a non-homogenous manner is of particular purpose of reducing active catalyst catalytic reactivity ratio within close proximity to the interior shell of the non-homogenous thermocatalytic gaseous reactor.

“Non-reactive catalyst mode” refers to a operating mode where the catalyst has a minimal catalytic reactivity ratio relative to a maximal or optimized catalytic reactivity ratio. In this mode flowing the unreacted gaseous reactant over the active catalyst has minimal reactivity thus minimal reacted liquid products or reacted gaseous products are created from the unreacted gaseous reactants. One instance of this being a desired outcome is that the non-homogenous thermocatalytic gaseous real-time reactor volume is approaching the maximum reactor volume, or the actuator is approaching the maximum reactor position.

“Parallel flow configuration” refers to a configuration of an array of non-homogenous thermocatalytic gaseous reactors are organized as known in the art for parallel flow of the unreacted gaseous reactant between multiple non-homogenous thermocatalytic gaseous reactors.

“Power generation compressor” refers to a device capable of increasing the pressure (as known in the art to a turbomachinery compression stage, or piston) of an incoming medium (such as stream of residual gases downstream of the non-homogenous thermocatalytic gaseous reactor) for combustion by the combustor to create mechanical or electrical energy by subsequent expansion stage (as known in the art).

“Power generation system” refers to the aggregate of a compression stage, a combustion stage (or thermal input), and expansion stage to create mechanical and/or electrical energy. It is a fundamental goal of a power generation system downstream of the non-homogenous thermocatalytic gaseous reactor to minimize post-combustion carbon dioxide combustion products.

“Pressure differential sensor” refers to a sensor, as known in the art, that measures a pressure differential between two distinct points. In a preferred embodiment the pressure differential sensor is used to calculate real-time flow rates or real-time fouling within the non-homogenous thermocatalytic gaseous reactor (or across any individual non-homogenous thermocatalytic gaseous reactors such as between the inlet cross section and discharge cross section).

“Ratio” refers to any proportion though for non-specified ratios the default is on a mass basis. A relevant ratio can include the proportion of an unreacted gaseous reactant to reacted liquid product or reacted gaseous product indicative of the catalytic reactivity ratio.

Another instance can be a hydrogen to carbon ratio before and after active catalyst exposure of the unreacted gaseous reactants.

“Reacted gaseous product” refers to the gaseous substance produced as a result of the chemical reaction within the thermocatalytic reactor after active catalyst exposure.

“Reacted liquid product” refers to the liquid substance produced as a result of the chemical reaction within the thermocatalytic reactor after active catalyst exposure.

“Reactor mode” refers to operating envelop conditions of the non-homogenous thermocatalytic gaseous reactor for modes including active catalyst mode, non-reactive catalyst mode, catalyst discharge mode, catalyst fill mode, catalyst transition mode, and/or standby catalyst mode.

“Reactor physical parameters set” refers to a minimum set of individual parameters characterizing physical metrics, particularly physical metrics in which regulating control of non-homogenous thermocatalytic gaseous reactor is a function of, including maximum reactor volume, minimum reactor volume, and real-time reactor volume.

“Reactor point parameter set” refers to a minimum set of individual parameters for regulating control of non-homogenous thermocatalytic gaseous reactor included by the control system as a function of real-time operating conditions consisting of at least two of meta sensor or actual sensor measuring a physical reactor data point specific to the physical point in which the actual sensor is placed. The set of individual parameters can include a minimum and maximum real-time flow rate, and a minimum and maximum real-time temperature.

“Reactor pressure differential” refers to actual resulting measurements made by a pressure differential sensor, which is the measure difference in pressure between the two sensor ports.

“Real-time flow rate” refers to the then current flow rate typically achieved through an actual sensor or other monitoring system (or even calculated by a multi-parametric function creating a “meta” real-time flow rate.

“Real-time operating conditions” refers to the current and precise parametric values which can include real-time flow rate, real-time temperature, reactor pressure differential, etc.

“Real-time reactor volume” refers to the then current actual volume of the non-homogenous thermocatalytic gaseous reactor.

“Real-time temperature” refers to the current and precise temperature values for a specific instance within the non-homogenous thermocatalytic gaseous reactor or any specific instance upstream or downstream of the non-homogenous thermocatalytic gaseous reactor.

“Real-time unreacted gaseous reactant flow regulator” refers to a device or system that continuously monitors and regulates the flow rate of unreacted gaseous reactants into the reactor, in real-time, to maintain a desired concentration or ratio of reactants within the reactor.

“Real-time unreacted gaseous reactant inlet temperature” refers to the temperature of the gaseous reactant entering the reactor at the moment of measurement, as opposed to the temperature of the unreacted gaseous reactant within the reactor, which is typically monitored and controlled in real-time to maintain optimal reaction conditions.

“Series flow configuration” refers to a configuration of an array of non-homogenous thermocatalytic gaseous reactors are organized as known in the art for series flow of the unreacted gaseous reactant between multiple non-homogenous thermocatalytic gaseous reactors.

“Solid reacted product” refers to the resulting solid material having undergone a chemical reaction or transformation within the non-homogenous thermocatalytic gaseous reactor from at least one of the unreacted gaseous reactants.

“Standby catalyst mode” refers to a state in which the non-homogenous thermocatalytic gaseous reactor has real-time operating conditions closely approaching (though critically not yet) operating conditions in which a relatively quick change in real-time temperature or real-time flow rate places the unreacted gaseous reactants into an active catalyst mode. The fundamental purpose of having the non-homogenous thermocatalytic gaseous reactor in the standby catalyst mode is such that a minimum amount of time is required for the non-homogenous thermocatalytic gaseous reactor to transition to the active catalyst mode, with the primary driver being the highest realizable catalytic reactivity ratio (i.e., an initial ratio of gaseous hydrogen as reacted gaseous product compared to the unreacted gaseous reactant (e.g., gaseous methane) so as to minimize or eliminate either CO2 emissions from within the post-combustion emissions profile.

“Starter active catalyst” refers to the initial provided active catalyst that seeds subsequent reactivity of active catalyst, though at a reduced catalytic reactivity ratio at a zero on-stream time for the real-time flow rate over the subsequently grown active catalyst producing a solid reacted product on the progressively increasing catalytic reactivity ratio.

“Stream of residual gases” refers to unreacted gaseous reactants resulting as a byproduct stream of residual gases reacted gaseous product or reacted.

“Transit time” refers to the duration of time between traveling from a first location to a second location, with the understanding that the anticipated transit time may be a calculated or projected value based on a subsequent future condition (i.e., transit time as a basis for meta sensor transit time), with avoiding practical conditions for fouling the non-homogenous thermocatalytic gaseous reactor as unreacted gaseous reactants pass over the active catalyst within the non-homogenous thermocatalytic gaseous reactor.

“Unreacted gaseous reactant” refers to a gaseous substance present within the reactor that has not yet participated in a chemical reaction with the catalyst or other reactants.

“Vacuum” refers to in this context, “vacuum” refers to a condition where the system or reactor is operated at a sub-atmospheric pressure, typically lower than atmospheric pressure, often achieved using a vacuum pump or valve.

“Water combustion product” refers to steam or water vapor resulting from the combustion in the combustor of a fuel containing hydrogen that undergoes oxidation from hydrogen to water.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a hybrid perspective of major components with the non-homogenous thermocatalytic gaseous reactor as well as flow communications between the major components.

FIG. 2 illustrates a more detailed perspective of major components within the non-homogenous thermocatalytic gaseous reactor.

FIG. 3 illustrates the feedforward control system preferably utilized for control of the non-homogenous thermocatalytic gaseous reactor.

FIG. 4 illustrates a network as well as an array of non-homogenous thermocatalytic gaseous reactors.

### DETAILED DESCRIPTION

The non-homogenous thermocatalytic gaseous reactor, also referred to as “NTGR”, is a reactor in which the internal flows are intentionally non-homogenous throughout the active area again to intentionally drive variations in catalytic reactivity ratios. Variations, including distinct zones within the non-homogenous thermocatalytic gaseous reactor are also intentional zones having an absence of active catalyst. This is particularly important when solids are grown directly on the active catalyst, especially when such solids have an adhesion strength greater than 5 kPa (or preferably when greater than 50 kPa, particularly when greater than 100 kPa, and specifically when greater than 200 kPa). The growth of solid reacted product on the active catalyst creates undesirable fouling limiting catalyst on-stream times and more significantly undesired irreversible flow diverters which can lead to severe limitations of non-homogenous thermocatalytic gaseous reactor performance over extended operational periods. Notably the creation of multi-wall carbon nanotubes “MWCNT” by solid reacted product growth on the active catalyst where the active catalyst becomes an end cap of the MWCNT. It is known within the art that the solid reacted product growth is a function of numerous multi-parametric variables including maximum active temperature threshold, minimum active temperature threshold, maximum active unreacted gaseous reactant flow regulator threshold, and minimum active unreacted gaseous reactant flow regulator threshold all of which vary for each distinct combination of metals (plus other additives) within the active catalyst. Therefore, the absence of active catalyst, particularly a catalyst that reduces the minimum active temperature threshold, from any unreacted gaseous reactants on all interior shell whether it be interior-facing side or exterior-facing side. The long-term prevention of fouling has a particularly preferred embodiment where no active catalyst, even an active catalyst never realizing any real-time operating conditions that yield solid reacted products is present on the interior shell.

The active catalyst in most instances, as known in the art, is a multi-metal catalyst most often comprised of two distinct metals. In a preferred embodiment the active catalyst is comprised of at least two metals. The active catalyst further comprised of additional metals with the ability to improve catalytic reactivity ratio are preferred. A specifically preferred catalyst has three distinct metals, notably comprised of copper “Cu”, nickel “Ni” and manganese “Mn”, and a specifically preferred catalyst has the approximate atomic ratio of Cu55Ni44Mn1. It is understood that the relative ratio between the individual metals remains as anticipated within the “approximate” terminology to as much as a plus or minus 10 percent variance from the indicated approximate atomic ratio. The addition of manganese enhances the catalyst activity without being bound by theory, especially for the creation starter active catalysts.

In a particularly preferred embodiment, the interior shell of the non-homogenous thermocatalytic gaseous reactor is void of those metals within the active catalyst. In a specifically preferred embodiment, the interior shell of the non-homogenous thermocatalytic gaseous reactor is also void of any metals or metal oxides in which the catalytic reactivity ratio is higher than for the metals within the active catalyst, notably within the same temperature real-time operating conditions for the non-homogenous thermocatalytic gaseous reactor. The absolutely preferred embodiment has the interior shell made only of metals or metal oxides in which the catalytic reactivity ratio is at least 50% (preferably at least 70% and specifically preferred at least 90%) lower than for the metals within the active catalyst, notably within the approximately same temperature and/or real-time flow rate real-time operating conditions for the non-homogenous thermocatalytic gaseous reactor.

Furthermore, the creation of solid reacted products occupies more volume within the non-homogenous thermocatalytic gaseous reactor with increasing on-stream time. This condition increases the opportunity for fouling of the resulting solid reacted products and therefore increased entanglement of the resulting solid reacted products. The optimal performance of the non-homogenous thermocatalytic gaseous reactor enables solid reacted products to remain as distinct powders emanating from the active catalyst, preferably distinct powders such that the active catalyst remains as the solid reacted products end cap. Particularly preferred real-time operating conditions further prevents the high-levels of active catalyst encapsulation by the solid reacted products, where high-levels is defined as at most 90% encapsulation, preferably at most 80%, particularly preferred at most 70%, and specifically preferred at most 50%.

The non-homogenous thermocatalytic gaseous reactor 102 is further comprised of an integral reactor flow diverter positioned above a bottom segment of the interior shell of the non-homogenous thermocatalytic gaseous reactor such that the position doesn't inhibit the change in real-time reactor volume between the minimum reactor position having a minimum reactor volume and the maximum reactor position having a maximum reactor volume. Another aspect of the invention is the utilization of a reverse flow (i.e., back-flow direction) of the unreacted gaseous reactant combined with an integral flow diverter to reduce the catalytic reactivity ratio on the surface of the interior shell by at least 5% as compared to the forward direction of the unreacted gaseous reactant at least 50 microns from the interior shell of the non-homogenous thermocatalytic gaseous reactor.

Another integral reactor flow diverter is positioned below a top reactor segment of the interior shell of the non-homogenous thermocatalytic gaseous reactor such that the position doesn't inhibit the change in real-time reactor volume between the minimum reactor position having a minimum reactor volume and the maximum reactor position having a maximum reactor volume.

The utilization of integral flow diverters in general increases a diverted residence transit time by at least 1% of the reverse flow unreacted gaseous reactant stream by diverting the reverse flow into the forward stream as compared to the transit time without any integral flow diverters. A particularly preferred embodiment also varies back-flow velocity such that a fast flow of the unreacted gaseous reactant combined with a integral flow diverter reduces the catalytic reactivity ratio on the interior shell by at least 5% as compared to a slower flow back-flow velocity that is at least 50 microns from the interior shell of the non-homogenous thermocatalytic gaseous reactor.

Yet another preferred embodiment, though not shown but understood to be approximately positioned on the interior-facing side of the interior shell, is the utilization of a replaceable reactor sleeve. The replaceable reactor sleeve is preferably void of an active catalyst so as to further limit fouling on the interior shell. Alternatively, the replaceable reactor sleeve can intentionally have active catalyst therefore concurrently creating solid reacted product placement on the replaceable reactor sleeve for subsequent utilization as a functionalized substrate providing at least one of a thermal conductivity or an electrical conductivity enhancement greater by at least 5% than a non-functionalized substrate (i.e., no solid reacted product).

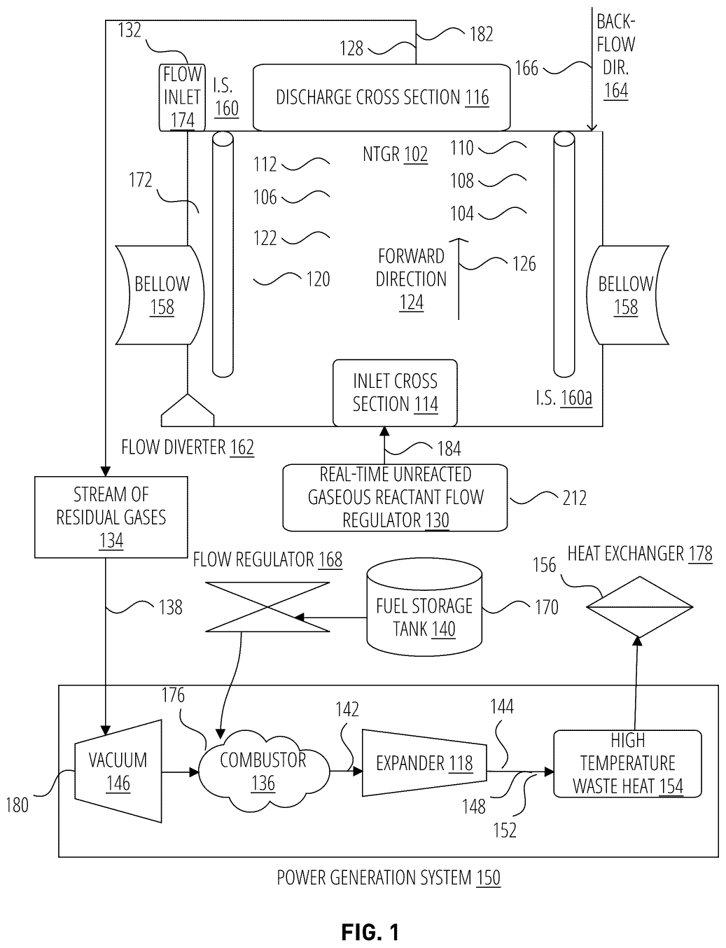

Turning to FIG. 1, FIG. 1 depicts a preferred embodiment of the non-homogenous thermocatalytic gaseous reactor 102 has a reactor point parameter set 104 in each major section of the non-homogenous thermocatalytic gaseous reactor 102 such that the unreacted gaseous reactant 212 is in gaseous fluid communications 184 (only shown here upstream of the inlet cross section 114), but throughout the non-homogenous thermocatalytic gaseous reactor 102. The parameters include a minimum real-time flow rate 182, a maximum real-time flow rate 182, a minimum real-time temperature 128, and a maximum real-time temperature 128. The real-time temperatures 128 are shown downstream of the discharge cross section 116, though not depicted in this figure it is understood that monitoring at the flow inlet port 174, the flow diverter 162, the inlet cross section 114, the interior shells 160, the bellows 158, the vacuum 146 (which is also under normal operation within the power generation system 150 as the power generation compressor 180), the combustor 136, the expander 118, and the high temperature waste heat 154 with the heat exchanger 178 removing waste heat from the power generation system 150 are known in the art.

The major sections of the non-homogenous thermocatalytic gaseous reactor include the inlet cross section 114, the discharge cross section 116, and the bellows 158 in order to regulate the non-homogenous thermocatalytic gaseous reactor 102 volume between the minimum reactor volume and the maximum reactor volume. The preferred embodiment additionally has at least one flow inlet port 174 to establish a back-flow direction 164 operating at a back-flow velocity 166 for at least a portion of the unreacted gaseous reactant 212 to enter the non-homogenous thermocatalytic gaseous reactor 102. Though not depicted in this figure, it is understood that unreacted gaseous reactant 212 enters through at least one real-time unreacted gaseous reactant flow regulator 130 (as shown upstream of the inlet cross section 114) and preferably through at least one flow inlet port 174 (as shown only on the upper lefthand side of the interior shells 160 notably the interior-facing side 120) with particularly preferred flow inlet ports on the upper righthand side, and specifically preferred flow inlet ports in close proximity to the flow diverters (of which as depicted is only shown on the lower lefthand side of the non-homogenous thermocatalytic gaseous reactor 102). The flow diverter 162 redirects the unreacted gaseous reactant from a back-flow direction 164 to a forward direction 124 after the unreacted gaseous reactant takes an active role of cooling the interior shells 160, thus further reducing the active catalyst 204 from growing solid reacted products on the interior shells 160.

The bellows 158, though depicted as a single segment on each side of the non-homogenous thermocatalytic gaseous reactor 102, will have as many segments as a necessary to vary the volume of the non-homogenous thermocatalytic gaseous reactor 102 between the minimum reactor volume and the maximum reactor volume. Also not depicted, the interior-facing side of the non-homogenous thermocatalytic gaseous reactor 102 could be the convex sector of the bellow 158 replacing the interior shells 160. Another embodiment, again not shown, is the interior shells 160 can be segmented and effectively telescoping as the non-homogenous thermocatalytic gaseous reactor 102 expands from the minimum reactor position to the maximum reactor position respectively for the minimum reactor volume to the maximum reactor volume.

A particularly preferred embodiment of the interior shell is flexible and the interior-facing side of the interior shell has at least two convex sectors in structural communications with each other, preferably where the at least two convex sectors have an at least one flow diverter in structural communications with the interior-facing side of the interior shell in order to divert flow away from in between a first convex sector and a second convex sector.

A preferred embodiment for the integral bellow actuator is placement approximately within the bellow to limit solid reacted product fouling on the exposed surfaces of the integral bellow actuator, while also preventing a gaseous leakage outside of the non-homogenous thermocatalytic gaseous reactor.

A preferred embodiment for the integral reactor actuator is placement approximately external of the non-homogenous thermocatalytic gaseous reactor to limit solid reacted product fouling on the exposed surfaces of the integral reactor actuator, while also preventing a gaseous leakage outside of the non-homogenous thermocatalytic gaseous reactor. A particularly preferred embodiment is such that the integral reactor actuator also functions as the integral bellow actuator. A specifically preferred embodiment for varying the non-homogenous thermocatalytic gaseous real-time reactor volume is the utilization of a twisted bellow operational to minimize unreacted gaseous reactant turbulence and resulting pressure drop of the unreacted gaseous reactant within the non-homogenous thermocatalytic gaseous reactor while concurrently enabling dynamic sizing between the minimum reactor volume and the maximum reactor volume. A preferred embodiment of both the integral reactor actuator and integral bellow actuator is a “zipper” actuator, as known in the art, with a particularly preferred zipper actuator being void of a thermal coefficient of expansion differential (i.e., less than 90% the thermal coefficient of expansion of steel) to avoid limiting the extension or a retraction of the integral reactor actuators and integral bellow actuators resulting from any real-time temperature variations within the non-homogenous thermocatalytic gaseous reactor.

The non-homogenous thermocatalytic gaseous reactor has unreacted gaseous reactant that enters the non-homogenous thermocatalytic gaseous reactor, as regulated by at least one the real-time unreacted gaseous reactant flow regulator though preferably one distinct flow regulator for each of the inlet cross section and interior shell portion of the non-homogenous thermocatalytic gaseous reactor.

The non-homogenous thermocatalytic gaseous reactor contains an active catalyst having an active catalyst parameter set that includes a minimum active temperature threshold and maximum active temperature threshold, and a minimum active unreacted gaseous reactant flow regulator threshold and a maximum active unreacted gaseous reactant flow regulator threshold in which forward flow velocity and back-flow velocity is established for which real-time operating conditions in between the threshold limits enable the active catalyst to create solid reacted product, reacted liquid product and/or stream of residual gases. The real-time unreacted gaseous reactant flow regulator controls the forward direction with the forward flow velocity through the inlet cross section at a real-time unreacted gaseous reactant inlet temperature into the non-homogenous thermocatalytic gaseous reactor flowing over the active catalyst of the non-homogenous thermocatalytic gaseous reactor to create at least one of a reacted gaseous product or a reacted liquid product. The non-homogenous thermocatalytic gaseous reactor has real-time flow rate over the inlet cross section of the non-homogenous thermocatalytic gaseous reactor that varies by at least 5 percent between the minimum real-time flow rate over the inlet cross section and the maximum real-time flow rate over the inlet cross section, and whereby the active catalyst grows a solid reacted product in physical communications with the active catalyst when at least 5 percent of the real-time flow rate is between the minimum active unreacted gaseous reactant flow regulator threshold and the maximum active unreacted gaseous reactant flow regulator threshold and the maximum real-time temperature is between the minimum active temperature threshold and the maximum active temperature threshold and the active catalyst creates a stream of residual gases comprised of at least one of an unreacted gaseous reactant and a reacted gaseous product. Counter to the desired real-time operating conditions directly entering the non-homogenous thermocatalytic gaseous reactor through the inlet cross section 114

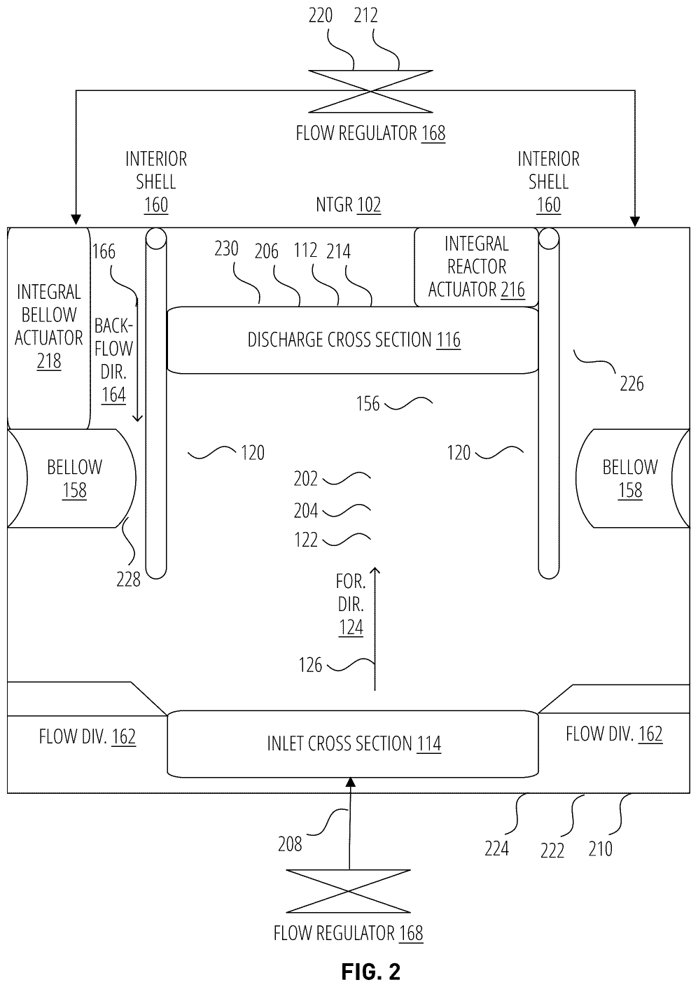

Contrary to traditional catalytic reactors, the non-homogenous thermocatalytic gaseous reactor has at least two functionality modes 108 due to the preferred embodiment of creating both reacted gaseous products and solid reacted products. The at least two functionality modes include an active catalyst mode, a non-reactive catalyst mode, a standby catalyst mode, a catalyst fill mode, a catalyst discharge mode, and a catalyst transition mode. The active catalyst mode is the mode in which the active catalyst 204 transforms the unreacted gaseous reactant 212 into a minimum set of reacted liquid products, reacted gaseous products, and/or solid reacted products. The non-reactive catalyst mode is the opposite of the active catalyst mode such that minimal if any unreacted gaseous reactant 212 is transformed. The standby catalyst mode is the mode such that non-homogenous thermocatalytic gaseous reactor 102 transitions to the active catalyst mode with a minimal amount of unreacted gaseous reactant 212 not being transformed between the transit time 230 of unreacted gaseous reactant 212 between the inlet cross section 114 and the discharge cross section 116. The catalyst fill mode 412, though not depicted in this figure, will typically take place when the non-homogenous thermocatalytic gaseous reactor 102 is in its minimum reactor position corresponding to the minimum reactor volume such that the starter active catalyst 156 (not shown in this figure but substituting for the shown active catalyst 204 within FIG. 2). The catalyst discharge mode, also not depicted in this figure also within the depicted functionality modes 108, will typically take place when the non-homogenous thermocatalytic gaseous reactor 102 is in its maximum reactor position corresponding to the maximum reactor volume such that minimal if any active catalyst 204 now (in the preferred embodiment) has solid reacted products at least partially encapsulating the active catalyst 204) can readily evacuate from the non-homogenous thermocatalytic gaseous reactor 102 without fouling 172 the interior shells 160 or the bellows 158 (one of the primary reasons for the convex sector 228 (as shown in FIG. 2) whereas a concave sector is more likely to trap solid reacted products.

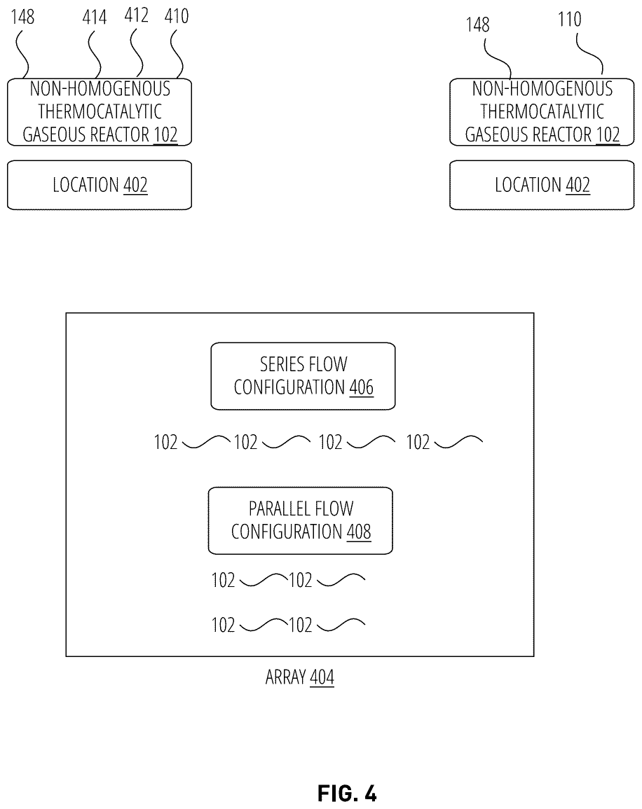

The non-homogenous thermocatalytic gaseous reactor 102 has a control system 222 (as shown in FIG. 2) regulates all control reactor point parameter set 104 in accordance to setpoints 324, reactor point parameter sets, functionality modes, active catalyst parameter set. The catalyst transition mode 414 (as shown in FIG. 4) is an intermediary mode during any transition between a first mode to a second mode of the functionality modes 108. A preferred real-time operating condition enables a recirculation of the unreacted gaseous reactant 212 (though not shown, as it is recognized in the art) recognizing that transition periods are suboptimal and therefore insufficient quantities of the unreacted gaseous reactant 212 is transformed. It is also recognized that, as known in the art, unreacted gaseous reactants 212 within the stream of residual gases can be separated downstream of the discharge cross section 116 for recirculation back into the non-homogenous thermocatalytic gaseous reactor 102. The preferred embodiment has this recirculation of unreacted gaseous reactants 212 entering through the flow inlet ports 174.

A particularly preferred embodiment of the non-homogenous thermocatalytic gaseous reactor 102 is the transformation of gaseous methane into gaseous hydrogen and solid reacted products (notably MWCNT) in order to decarbonize the production of electricity within a power generation system 150. In this embodiment, the power generation system 150 has a combustor 136 and a real-time unreacted gaseous reactant flow regulator 130 such that the control system 222 varies the unreacted gaseous reactant real-time flow rate from a slow real-time flow rate to a fast real-time flow rate (the fast real-time flow rate is at least one of 5 percent higher than the slow real-time flow rate and 1 percent higher than the maximum active unreacted gaseous reactant flow regulator threshold). This real-time operating conditions recognizes at least a set of conditions such that the non-homogenous thermocatalytic gaseous reactor 102 is already at its maximum reactor position and no additional solid reacted products can be created (including for the specific concern of fouling 172, especially between the inlet cross section 114 and the discharge cross section 116) where real-time operating conditions that exceed the maximum active unreacted gaseous reactant flow regulator threshold limits any further creation of solid reacted products. The control system therefore switches between the active catalyst mode to the non-reactive catalyst mode, recognizing that the catalyst transition mode may occur in between.

The control system 222 also regulates flow rates such that the switch from the slow real-time flow rate to the fast real-time flow rate has an impact on the recovery of waste heat from the active catalyst and the solid reacted product particularly prior to the functionality modes 108 becoming catalyst discharge mode where embedded thermal energy in the solid reacted products enhances the energy efficiency of the power generation system 150 while also preparing the solid reacted products for consumption (almost always requiring cooling). It is understood, though not shown, that this waste heat now embedded in the unreacted gaseous reactant 212 can be directly use in the power generation system 150 or preferably recirculated to a second non-homogenous thermocatalytic gaseous reactor 102 currently operating in an active catalyst mode. A particularly preferred embodiment has the control system vary the unreacted gaseous reactant real-time flow rate from a slow real-time flow rate to a fast real-time flow rate to the non-homogenous thermocatalytic gaseous reactor wherein the fast real-time flow rate is at least one of 5 percent higher than the slow real-time flow rate and 1 percent higher than the maximum active unreacted gaseous reactant flow regulator threshold during a switch of functionality modes from the active catalyst mode to the non-reactive catalyst mode resulting from the real-time reactor volume being within at least 0.1 percent of the maximum reactor volume as a result of the solid reacted product growing on the active catalyst.

Another feature of the invention when the non-homogenous thermocatalytic gaseous reactor 102 is co-located with the power generation system 150 is the utilization of high temperature waste heat downstream from the combustor to create a starter active catalyst since the high temperature waste heat is already at least 100 degrees Celsius higher than the maximum active temperature threshold of the non-homogenous thermocatalytic gaseous reactor. It is recognized that the combustor can utilize a wide range of fuels 138 including the reacted gaseous product or the reacted liquid product as a first fuel. A particularly advantageous co-location leverages the utilization of the power generation compressor 180 operational as the vacuum 146 during the final stage of transition mode for the non-homogenous thermocatalytic gaseous reactor 102 to catalyst discharge mode where the absence stream of residual gases 134, unreacted gaseous reactants 212 (including and notably gaseous methane 220) are evacuated. The evacuated gases removed are preferentially utilized as a first fuel as regulated by a flow regulator 168 (not shown as it is known in the art) for injection upstream of the combustor 136 and downstream of the non-homogenous thermocatalytic gaseous reactor 102, a second fuel also regulated by a second fuel flow regulator, more particularly preferred such that the control system increases by at least 2 percent a fuel flow ratio of the second fuel flow regulator: the first fuel flow regulator as diminishing amounts of stream of residual gases 134 occurs during increasing operating time of the vacuum 146 (also when co-located with power generation system 150 by its power generation compressor 180). The power generation compressor 180 operating as a vacuum 146 to remove the stream of residual gases from the non-homogenous thermocatalytic gaseous reactor occurs during a mode transition from an active catalyst mode 202 to a non-reactive catalyst mode.

The non-homogenous thermocatalytic gaseous reactor as noted earlier, within its preferred embodiment, has the active catalyst growing solid reacted products such that the active catalyst 204 becomes an end cap of MWCNTs. The growth of the MWCNTs occupies additional volume from within the non-homogenous thermocatalytic gaseous reactor 102 therefore requiring catalyst replacement to a new starter active catalyst 156 that serves as both providing a fresh highly active catalyst and an at least partial evacuation of solid reacted products with this catalyst discharge mode taking place preferentially when the real-time reactor volume is greater than 90 percent of the maximum reactor volume. Alternatively this at least partial evacuation of active catalyst 204 (now at least partially spent) when the catalytic reactivity ratio 110 diminishes as compared to a fresh active catalyst (i.e., starter active catalyst 156), which is calculated as a function of a downstream combustor sensor 142 measuring a mass ratio of a water combustion product 144 to a carbon dioxide combustion product 152 from the combustor 136 utilizing the reacted gaseous product (having a real-time flow rate 182 downstream of the discharge cross section 116) or the reacted liquid product as a fuel source (which be optionally stored in the fuel storage tank 140 with a regulated flow through the flow regulator 168 downstream of the fuel storage tank 140 and upstream of the combustor 136). Another fuel source, whether derived from the non-homogenous thermocatalytic gaseous reactor 102 or from any other secondary operation, is optionally gaseous hydrogen from a hydrogen storage tank 176 that injects upstream of the combustor 136. The resulting combustion products include water combustion product 144 and carbon dioxide combustion product 152 when the unreacted gaseous reactant 212 doesn't entirely transform into gaseous hydrogen and solid reacted products, collectively measured by an emissions profile 148 sensor as known in the art. The emissions profile 148 is gathered as a function of real-time operating conditions and time of the non-homogenous thermocatalytic gaseous reactor 102, with the downstream combustor sensor 142 (as shown immediately downstream of the combustor 136) positioned anywhere downstream of the combustor 136 though having the advantage either downstream of the expander 118 or high temperature waste heat 154 heat exchanger 178 of condensing out the water combustion products 144. The preferred combustor 136 is an external combustor (differentiated by the more traditional internal combustor) enabling more flexible and complete combustion particularly in this embodiment where the stream of residual gases 134 varies in its water combustion products 144 as well as carbon dioxide combustion product 152 and where this stream of residual gases 134 is the first fuel 138.

Each non-homogenous thermocatalytic gaseous reactor 102 has reactor physical parameters set 106 that represent the unique design features including minimum reactor volume, minimum reactor position, maximum reactor volume, and maximum reactor position. The further inclusion of conversion ratio 112, catalytic reactivity ratio 110, and functionality modes 108 are collectively part of the active catalyst parameter set 122 including as a function of real-time operating conditions and catalyst on-stream time. Real-time operating conditions not as a function of the catalyst state are generally referred to as reactor point parameter set 104.

The non-homogenous thermocatalytic gaseous reactor, as previously noted, preferred embodiment is actually an array 404 of non-homogenous thermocatalytic gaseous reactors 102, wherein the array of non-homogenous thermocatalytic gaseous reactors 102 consists of at least two individual non-homogenous thermocatalytic gaseous reactors 102 having a first non-homogenous thermocatalytic gaseous reactor 102 and a second non-homogenous thermocatalytic gaseous reactor 102, whereby the first non-homogenous thermocatalytic gaseous reactor 102 and the second non-homogenous thermocatalytic gaseous reactor 102 are in a gaseous fluid communications 184 when the first non-homogenous thermocatalytic gaseous reactor 102 is in a first reactor mode and the second non-homogenous thermocatalytic gaseous reactor 102 is in a second reactor mode, whereby the first reactor mode is different than the second reactor mode, whereby both the first reactor mode and the second reactor mode are selected from the at least two functionality modes 108, whereby the first non-homogenous thermocatalytic gaseous reactor 102 is comprised of a first flow regulator 168 of the unreacted gaseous reactant as regulated by the real-time unreacted gaseous reactant flow regulator 130 and a first heat exchanger 178 of the unreacted gaseous reactant 212, whereby the second non-homogenous thermocatalytic gaseous reactor 102 is comprised of a second flow regulator 168 of the unreacted gaseous reactant 212 as regulated by the real-time unreacted gaseous reactant flow regulator 130 and a second heat exchanger 178 of the unreacted gaseous reactant 212, wherein at least one of the first flow regulator 168 of the unreacted gaseous reactant 212 is controlled independently from the second flow regulator 168 of the unreacted gaseous reactant 212, or wherein at least one of the first heat exchanger 178 of the unreacted gaseous reactant 212 is controlled independently from the second heat exchanger 178 of the unreacted gaseous reactant 212, and whereby the independent control of the first non-homogenous thermocatalytic gaseous reactor 102 from the second non-homogenous thermocatalytic gaseous reactor 102 yields a first conversion ratio 112 of the unreacted gaseous reactant 212: reacted gaseous product or reacted liquid product leaving the first non-homogenous thermocatalytic gaseous reactor 102 that is different by at least two percent from a second conversion ratio 112 of the unreacted gaseous reactant: reacted gaseous product or reacted liquid product leaving the first non-homogenous thermocatalytic gaseous reactor 102 from leaving the second non-homogenous thermocatalytic gaseous reactor 102.

It is understood that references of forward direction 124 is simply opposite of the back-flow direction 164, though the preferred utilization of the forward direction 124 is the same as the flow between the inlet cross section 114 to the discharge cross section 116. The non-homogenous thermocatalytic gaseous reactor control system 222 is operable to vary at least one of an unreacted gaseous reactant flow direction from a forward direction 124 by the first real-time unreacted gaseous reactant flow regulator to a back-flow direction 164 by the second real-time unreacted gaseous reactant flow regulator within the non-homogenous thermocatalytic gaseous reactor when the non-homogenous thermocatalytic gaseous reactor is in an active catalyst mode, and wherein the real-time unreacted gaseous reactant flow regulator having the back-flow direction is closer to the interior shell of the non-homogenous thermocatalytic gaseous reactor than the real-time unreacted gaseous reactant flow regulator having the forward direction by at least 0.1 inches. It is always the goal of the control system 222 to have a lower conversion ratio 112 on any internal surfaces within the non-homogenous thermocatalytic gaseous reactor 102. One such method is for the back-flow direction having a back-flow velocity real-time flow rate that is faster than the forward direction having a forward flow velocity real-time flow rate by at least 5 percent. In most cases the velocity differential will need to be greater than 5 percent (particularly greater than 20 percent, and specifically greater than 40 percent) such that the counter-momentum from the forward direction 124 at forward flow velocity 126 will slow down the back-flow velocity such that the entire interior shell 160 is not protected against fouling 172.

Another preferred feature is a back-flow direction unreacted gaseous reactant stream having an initial back-flow direction unreacted gaseous reactant real-time flow rate and an initial back-flow direction unreacted gaseous reactant real-time temperature, and a forward direction unreacted gaseous reactant stream having an initial forward direction unreacted gaseous reactant real-time flow rate and an initial forward direction unreacted gaseous reactant real-time temperature, whereby the forward direction unreacted gaseous reactant stream and the back-flow direction unreacted gaseous reactant stream are both on the interior-facing side 120 of the interior shell 160 such that the back-flow direction of the unreacted gaseous reactant stream is at least 5 percent closer to the interior shell 160 than the forward direction 124 of the unreacted gaseous reactant 212 stream, and the initial back-flow velocity 166 of the back-flow direction 164 for the unreacted gaseous reactant 212 stream is greater than the initial forward flow velocity 126 of the forward direction 124 unreacted gaseous reactant 212 stream.

A more preferred embodiment also both the initial back-flow direction unreacted gaseous reactant real-time flow rate at least 5 percent higher than the initial forward direction unreacted gaseous reactant real-time flow rate and the initial back-flow direction unreacted gaseous reactant real-time temperature at least 5 degrees Celsius lower than the initial forward direction unreacted gaseous reactant real-time temperature. The positioning of the flow inlet port 174 for the back-flow direction 164 of the back-flow direction unreacted gaseous reactant stream enters the non-homogenous thermocatalytic gaseous reactor above by at least 1 inch higher than the flow inlet port 174 of the forward direction unreacted gaseous reactant stream.

As previously noted, an external combustor 136 has more fuel flexibility than an internal combustor 136 therefore enabling a second fuel having a second fuel flow regulator to be injected upstream of the combustor 136 such that the control system 222 operates the first fuel flow regulator and the second fuel flow regulator in order to vary by at least 2 percent a fuel flow ratio of the second fuel flow regulator: the first fuel flow regulator in order to modulate the emissions profile 148 for the multi-fuel combustion by at least 1 percent compared to a first fuel emissions profile created downstream of the external combustor.

An aggregate real-time flow rate of the stream of residual gases real-time flow rate and the fuel real-time flow rate is an important parameter for in transit mobility from a current first location to a second next location projected to require a transit time greater than a fouling time for the non-homogenous thermocatalytic gaseous reactor operating time at a current real-time operating conditions, especially when the real-time reactor volume is within at least 0.1 percent of a maximum reactor volume as a result of a solid reacted product growing on the active catalyst that could create a fouling condition if the stream of residual gases is not reduced by at least 1% to therefore reduce the quantity of solid reacted products produced within the non-homogenous thermocatalytic gaseous reactor. In this condition, the control system switches the non-homogenous thermocatalytic gaseous reactor from the active catalyst mode to the non-reactive catalyst mode.

Another preferred embodiment of the control system further includes a pressure differential sensor to measure the reactor pressure differential between the inlet cross section of the non-homogenous thermocatalytic gaseous reactor and the discharge cross section of the non-homogenous thermocatalytic gaseous reactor to regulate the real-time reactor volume into an expandable real-time position between the minimum reactor position having a minimum reactor volume and the maximum reactor position having a maximum reactor volume as a function of the reactor pressure differential.

Yet another preferred embodiment of the control system further regulates the real-time reactor volume of the non-homogenous thermocatalytic gaseous reactor as a function of catalytic reactivity ratio at the inlet cross section to the catalytic reactivity ratio at the discharge cross section.

Critical monitoring of the real-time temperature over the inlet cross section is required to maintain by at least 5% below the real-time temperature over the interior shell of the non-homogenous thermocatalytic gaseous reactor between the minimum real-time temperature over the interior shell inlet cross section. Another critical monitoring enables the active catalyst to grow a solid reacted product on the active catalyst by having the real-time flow rate at least 5% above the minimum active unreacted gaseous reactant flow regulator threshold and at least below the maximum active unreacted gaseous reactant flow regulator threshold with both preferably being a function of the real-time temperature.

Yet another critical condition has a first portion of the unreacted gaseous reactant flowing over an exterior-facing side of the interior shell and a second portion of the unreacted gaseous reactant flowing over an interior-facing side of the interior shell, such that the first portion of the unreacted gaseous reactant is less than the second portion of the unreacted gaseous reactant, and the real-time temperature of the exterior-facing side of the interior shell is at least 5 degrees Celsius lower than the real-time temperature of the interior-facing side of the interior shell and the real-time temperature of the exterior-facing side is at least 1 degree Celsius lower than the minimum active temperature threshold.

Another feature of the non-homogenous thermocatalytic gaseous reactor 102 is the integration of an expander 118, though not the same expander of the power generation system 150 such that expansion cooling of the unreacted gaseous reactant maintains the real-time temperature of the exterior-facing side below the minimum active temperature threshold to further reduce fouling. The preferred embodiment has the resulting expansion cooling in thermal communications with the interior shell 160 of the non-homogenous thermocatalytic gaseous reactor 102.

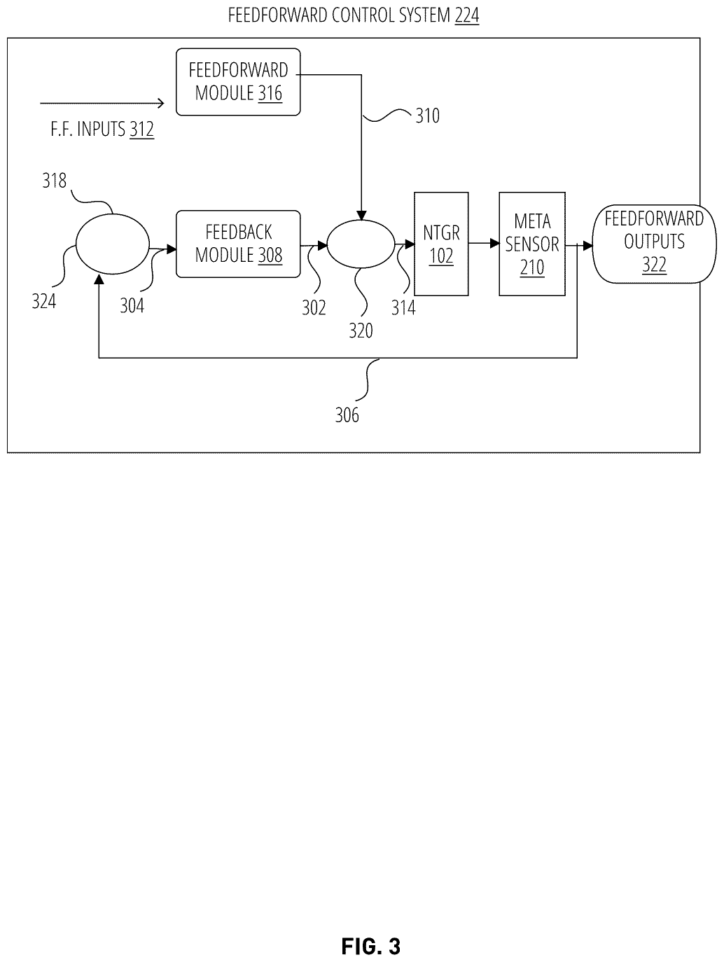

Turning to FIG. 2, FIG. 2 depicts a more detailed perspective of the non-homogenous thermocatalytic gaseous reactor 102. The unreacted gaseous reactant 212 flows through the flow regulator 168 into the inlet cross section 114 (as shown in the bottom of the figure) where the inlet temperature 208 is monitored. Additional unreacted gaseous reactant 212 flows from the top of the figure into the top flow regulator 168 before being in gaseous fluid communications 184, as shown here within the cavity formed between the interior shell 160 and the outer wall of the non-homogenous thermocatalytic gaseous reactor 102 (shown in the same place as the back-flow direction 164 having a back-flow velocity 166). Not shown in FIG. 1 (but still featured in most instances) is the integral bellow actuator 218 in physical communications with the bellow 158 (as shown only on the lefthand side, but definitely also in physical communications with the bellow 158 on the righthand side. A fundamental feature of the invention is for the bellow 158 to have an interior-facing side 120 being a convex sector 228 so as to reduce fouling 172 by solid reacted products. The unreacted gaseous reactant 212 flowing in the back-flow direction 164 is definitely diverted, if not previously by the bellows 158, by the flow diverter 162 such that the unreacted gaseous reactant 212 enters the bulk of the flow through the inlet cross section 114 in a now more forward direction 124 at a forward flow velocity 126. Not bound to theory, the starter active catalyst 156 has greater buoyancy as less solid reacted products are encapsulating the active catalyst 204 which is parameterized by active catalyst parameter set 122. The non-homogenous thermocatalytic gaseous reactor 102 has functionality modes 108 inclusive of active catalyst mode 202 with an intentional non-homogenous flow of unreacted gaseous reactant 212 such that active catalyst 204 transforms the unreacted gaseous reactant 212 between the inlet cross section 114 and the discharge cross section 116. One embodiment of the invention to alter the volume of the non-homogenous thermocatalytic gaseous reactor 102 between the minimum reactor volume and the maximum reactor volume is through an integral reactor actuator 216 in physical communications with the discharge cross section 116 (though alternatively, not shown, it could be in physical communications with the inlet cross section 114). The exterior-facing side 226 is between the interior shell 160 and the outer wall of the non-homogenous thermocatalytic gaseous reactor 102 (as shown on the upper righthand side). The particularly preferred embodiment has both (as shown on the upper lefthand side) bellows 158 and interior shells 160 to minimize fouling 172 of the non-homogenous thermocatalytic gaseous reactor 102 by both back-flow direction, back-flow velocity 166 (exceeding maximum active unreacted gaseous reactant flow regulator threshold) and real-time temperature 128 below the minimum active temperature threshold. It is understood that real-time flow rates and real-time temperatures within every major section of the non-homogenous thermocatalytic gaseous reactor 102 and the power generation system 150, though not explicitly shown in each instance. The control system 222 is detailed in FIG. 3 including the preferred embodiment of a feedforward control system 224 using a meta sensor 210 including this input as the feedforward inputs 312 having a function of multiple reactor point parameter sets including at a minimum the transit time 230, conversion ratio 112, and pressure differential sensor 214. The stream of residual gases 134 exits the flow discharge port 206 (neither of which are shown, but both would be downstream of the discharge cross section 116.

Turning to FIG. 3, FIG. 3 depicts the feedforward control system 224 which is the preferred embodiment of control system 222 for monitoring all inputs and controlling all regulated outputs.

In a number of embodiments, the non-homogenous thermocatalytic gaseous reactor 102 uses a control system 222 as depicted in FIG. 3. The operations of the control system 222 may be carried out by the feedback module 308 at the minimum and preferably with the feedforward module 316 or may be embodied in different hardware. The control system 222 is configured to control the real-time temperature 128 at the discharge cross section 116 at a minimum. The real-time temperature 128 may be one of the non-homogenous thermocatalytic gaseous reactor 102 sensor or a meta sensor 210. A feedback module 308 is configured to issue a feedback command 302 when the real-time temperature 128 sensor, as communicated through the feedback loop 306, moves from a setpoint 324 to produce a feedback error 304 (setpoint 324-real-time temperature 128). Accordingly, the feedback module 308 only begins to respond after the real-time temperature 128 has deviated from the setpoint 324 by the feedback error 304.

A feedforward module 316 is included to monitor active catalyst parameter set 122 by establishing a meta sensor 210 in the non-homogenous thermocatalytic gaseous reactor 102, which is used to predict an impact on a wide range of reactor point parameter set and active catalyst parameter set with particular monitoring of real-time temperature 128 at the discharge cross section 116 exiting the non-homogenous thermocatalytic gaseous reactor 102, before the real-time temperature 128 is able to measure a resulting temperature increase. The feedforward module 316 receives feedforward inputs 312, such as from a real-time temperature 128 at the flow inlet port 174, including for example, real-time flow rates 182 at various major sections of the non-homogenous thermocatalytic gaseous reactor 102, real-time reactor volume, and transit time 230. The feedforward module 316 computes a generated catalyst catalytic reactivity ratio 110 as a prediction of an upcoming temperature increase and initiates preemptive control to counteract the predicted increase. Based on the computed generated meta sensor 210, the feedforward module 316 issues a feedforward command 310 that alone or in addition to the feedback command 302 from the feedback module 308 determines a commanded feedforward modified command 314 to the non-homogenous thermocatalytic gaseous reactor 102 and maintain the real-time temperature 128 at the discharge cross section 116 close to the setpoint 324.

Turning to FIG. 4, FIG. 4 depicts both multiple location 402 operations as well as multiple configuration operations. Though not shown, as it is known in the art, the unreacted gaseous reactant 212 can bypass or preferably recirculate into the non-homogenous thermocatalytic gaseous reactor 102 for a second (or next) pass or preferably into a next non-homogenous thermocatalytic gaseous reactor 102 that is arranged in an array 404 (as shown in FIG. 4) either in a series flow configuration 406 or a parallel flow configuration 408 when at least one of a fouling of the active catalyst within the interior shell 160 of the non-homogenous thermocatalytic gaseous reactor 102, the real-time reactor volume is within at least 10 percent of the maximum reactor volume or a real-time temperature of the non-homogenous thermocatalytic gaseous reactor is lower than minimum active temperature threshold or a real-time flow rate of the unreacted gaseous reactant 212 as regulated by the real-time unreacted gaseous reactant flow regulator of the non-homogenous thermocatalytic gaseous reactor is higher than a maximum active unreacted gaseous reactant flow regulator threshold.

As shown a network or an array 404 of non-homogenous thermocatalytic gaseous reactor 102 are within the inventive scope. The series flow configuration 406 as shown, though can be any number greater than one, has four non-homogenous thermocatalytic gaseous reactor 102 in series which without being bound by theory increases the transformation of the unreacted gaseous reactants 212 into gaseous hydrogen (within the preferred embodiment, or any other reacted gaseous products) and solid reacted products (within the preferred embodiment, or any other reacted liquid products). The parallel flow configuration 408 as shown, though also can be any number greater than one, has two non-homogenous thermocatalytic gaseous reactors 102 in series with two parallel flows, being representative of having the network of non-homogenous thermocatalytic gaseous reactors 102 always having at least one non-homogenous thermocatalytic gaseous reactor 102 being in active catalyst mode 202. As shown a non-homogenous thermocatalytic gaseous reactor 102 can be co-located with a power generation system 150 and that the non-homogenous thermocatalytic gaseous reactor 102 can be placed at a first location 402 (as shown on the left) on a semi-permanent basis, or can be moved to a second location 402 (as shown on the right) for a next semi-permanent or temporary use, or can in fact be operational such as on a moving vehicle desirous of consuming a decarbonized (or reduced) fuel such as gaseous hydrogen resulting from the transformation of gaseous methane. Though not shown, as weighing a solid reacted product itself is not novel, this FIG. 4 clearly supports the measuring of solid reacted products following the catalyst discharge mode of a non-homogenous thermocatalytic gaseous reactor 102 to provide an authenticated emissions profile 148 as a functional of time beginning at the departure time of the first location 402 (left) and ending at the arrival time of the second location 402 (right).

The real-time operating conditions of the non-homogenous thermocatalytic gaseous reactor 102 is preferably as a function of at least one parameter selected from the group of potential to switch catalyst bed, potential to expand catalyst bed, potential to unload spent catalyst bed at current or next location, spare capacity to empty spent catalyst bed at next location, and the potential to empty and regenerate catalyst bed at next location so as to avoid spent catalyst bed “permanent” fouling.

When the non-homogenous thermocatalytic gaseous reactor is particularly mobile the high temperature waste heat downstream of the combustor the high temperature waste heat has a temperature that is at least 10 degrees Celsius greater than a minimum active temperature threshold of the active catalyst therefore enabling the production of a new active seed catalyst (a.k.a. Starter active catalyst) to be subsequently utilized within the non-homogenous thermocatalytic gaseous reactor. In addition, the non-homogenous thermocatalytic gaseous reactor as utilized in mobility applications with on-vehicle power generation system that have varying power demands (as compared to baseload power) yielding even more dynamic emissions profile. One of the preferred embodiments of the non-homogenous thermocatalytic gaseous reactor is to decarbonize energy production where the unreacted gaseous reactant is gaseous methane, and the solid reacted product is carbon nanotubes. The resulting solid reacted products in this instance contain and sequester carbon. The weighing of the resulting solid reacted products created at a second location from a first location enables an absolute amount of carbon sequestered to be determined, even when the weighing takes place following the arrival at the second location and therefore is both calculated and authenticated at a future time and then retroactively accounted for. Furthermore, when the actual fuel consumption is known, whether from the unreacted gaseous reactant, the resulting gaseous hydrogen, an electrical energy storage system (a.k.a. battery), or a second fuel from a second fuel storage tank, and the solid reacted product production is known, the feedforward control system can also provide an emissions profile as a function of time and location. The combustion emissions profile is also a function of at least one of the second real-time reactor volume corresponding to the second location (i.e., real-time position) relative to the first real-time reactor volume corresponding to the first location, a mass ratio of unreacted gaseous reactant to reacted gaseous product, a real-time capacity of the reacted gaseous product storage tank, a real-time capacity of an energy storage device (notably an electrical battery), an active catalyst on stream time within the non-homogenous thermocatalytic gaseous reactor, a unreacted gaseous reactant real-time flow rate, a real-time unreacted gaseous reactant real-time flow rate and further as a function of the active catalyst on stream time within the non-homogenous thermocatalytic gaseous reactor. A specifically preferred embodiment though utilizes a reacted gaseous product or post-combustion emissions profile downstream combustor sensor to detect mass ratio of the unreacted gas to the reacted gas percentage of hydrogen. Any set of actual measured sensor parameters in combination with any set of actual known reactor point parameter set can become a meta sensor utilized to calibrate a first reacted gas sensor determining a mass ratio of the unreacted gaseous reactant and the reacted gaseous product and a post-combustor sensor detecting a carbon dioxide combustion product resulting from combustion of the reacted gaseous product or reacted liquid product, and preferentially including the downstream combustor sensor.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A non-homogenous thermocatalytic gaseous reactor having a minimum real-time flow rate, a maximum real-time flow rate, a minimum real-time temperature, and a maximum real-time temperature across an inlet cross section into the non-homogenous thermocatalytic gaseous reactor comprised of an unreacted gaseous reactant, an interior shell of the non-homogenous thermocatalytic gaseous reactor, an active catalyst having a minimum active temperature threshold and maximum active temperature threshold, a minimum active unreacted gaseous reactant flow regulator threshold, a maximum active unreacted gaseous reactant flow regulator threshold, a real-time unreacted gaseous reactant flow regulator, a real-time unreacted gaseous reactant inlet temperature into the non-homogenous thermocatalytic gaseous reactor whereby the active catalyst of the non-homogenous thermocatalytic gaseous reactor creates at least one of a reacted gaseous product or a reacted liquid product, whereby the non-homogenous thermocatalytic gaseous reactor has real-time flow rate over the inlet cross section of the non-homogenous thermocatalytic gaseous reactor that varies by at least 5 percent between the minimum real-time flow rate over the inlet cross section and the maximum real-time flow rate over the inlet cross section, and whereby the active catalyst grows a solid reacted product in physical communications with the active catalyst when at least 5 percent of the real-time flow rate is between the minimum active unreacted gaseous reactant flow regulator threshold and the maximum active unreacted gaseous reactant flow regulator threshold and the maximum real-time temperature is between the minimum active temperature threshold and the maximum active temperature threshold and the active catalyst creates a stream of residual gases comprised of at least one of an unreacted gaseous reactant and a reacted gaseous product.

2. The non-homogenous thermocatalytic gaseous reactor of claim 1 has an at least two functionality modes, wherein the at least two functionality modes include an active catalyst mode, a non-reactive catalyst mode, a standby catalyst mode, a catalyst fill mode, a catalyst discharge mode, and a catalyst transition mode.

3. The non-homogenous thermocatalytic gaseous reactor of claim 2 further comprising a combustor, a real-time unreacted gaseous reactant flow regulator, and a control system operable to vary an unreacted gaseous reactant real-time flow rate from a slow real-time flow rate to a fast real-time flow rate to the non-homogenous thermocatalytic gaseous reactor wherein the fast real-time flow rate is at least one of 5 percent higher than the slow real-time flow rate and 1 percent higher than the maximum active unreacted gaseous reactant flow regulator threshold, wherein the control system switches the non-homogenous thermocatalytic gaseous reactor from the active catalyst mode to the non-reactive catalyst mode, wherein the control system switches from the slow real-time flow rate to the fast real-time flow rate, and whereby the combustor recovers a waste heat from the active catalyst and the solid reacted product.

4. The non-homogenous thermocatalytic gaseous reactor of claim 2 further comprising a real-time reactor volume expandable from a minimum reactor position having a minimum reactor volume to a maximum reactor position having a maximum reactor volume, a real-time unreacted gaseous reactant flow regulator, and a control system operable to vary an unreacted gaseous reactant real-time flow rate from a slow real-time flow rate to a fast real-time flow rate to the non-homogenous thermocatalytic gaseous reactor wherein the fast real-time flow rate is at least one of 5 percent higher than the slow real-time flow rate and 1 percent higher than the maximum active unreacted gaseous reactant flow regulator threshold, wherein the control system switches the non-homogenous thermocatalytic gaseous reactor from the active catalyst mode to the non-reactive catalyst mode when the real-time reactor volume is within at least 0.1 percent of the maximum reactor volume as a result of the solid reacted product growing on the active catalyst.

5. The non-homogenous thermocatalytic gaseous reactor of claim 2 further comprising a combustor having a high temperature waste heat downstream from the combustor to create a starter active catalyst whereby the high temperature waste heat is at least 100 degrees Celsius higher than the maximum active temperature threshold of the non-homogenous thermocatalytic gaseous reactor, and whereby the combustor utilizes the reacted gaseous product or the reacted liquid product as a first fuel.

6. The non-homogenous thermocatalytic gaseous reactor of claim 2 further comprising a vacuum to remove from the non-homogenous thermocatalytic gaseous reactor the stream of residual gases as a first fuel, a combustor downstream of the non-homogenous thermocatalytic gaseous reactor, a second fuel having a second fuel flow regulator, whereby the first fuel has a first fuel flow regulator, a control system to operate the first fuel flow regulator and the second fuel flow regulator, and wherein the control system increases by at least 2 percent a fuel flow ratio of the second fuel flow regulator: the first fuel flow regulator due to diminishing amounts of stream of residual gases as a function of operating time of the vacuum.

7. The non-homogenous thermocatalytic gaseous reactor of claim 1 whereby the non-homogenous thermocatalytic gaseous reactor has a real-time reactor volume expandable from a minimum reactor position having a minimum reactor volume to a maximum reactor position having a maximum reactor volume wherein the active catalyst starts in the non-homogenous thermocatalytic gaseous reactor as a starter active catalyst and is replaced with a new starter active catalyst as a function of at least one of a catalytic reactivity ratio of the unreacted gaseous reactant to the reacted gaseous product, or the real-time reactor volume is greater than 90 percent of the maximum reactor volume.

8. The non-homogenous thermocatalytic gaseous reactor of claim 7 whereby the catalytic reactivity ratio is calculated as a function of a downstream combustor sensor measuring a mass ratio of a water combustion product to a carbon dioxide combustion product from a combustor whereby the combustor utilizes the reacted gaseous product or the reacted liquid product as a fuel source.

9. The non-homogenous thermocatalytic gaseous reactor of claim 1 whereby the non-homogenous thermocatalytic gaseous reactor has a real-time reactor volume is expandable from a minimum reactor position having a minimum reactor volume to a maximum reactor position having a maximum reactor volume; or whereby the unreacted gaseous reactant bypasses the non-homogenous thermocatalytic gaseous reactor when at least one of a fouling of the active catalyst within the interior shell of the non-homogenous thermocatalytic gaseous reactor, the real-time reactor volume is within at least 10 percent of the maximum reactor volume or a real-time temperature of the non-homogenous thermocatalytic gaseous reactor is lower than minimum active temperature threshold or a real-time flow rate of the unreacted gaseous reactant as regulated by the real-time unreacted gaseous reactant flow regulator of the non-homogenous thermocatalytic gaseous reactor is higher than a maximum active unreacted gaseous reactant flow regulator threshold.

10. The non-homogenous thermocatalytic gaseous reactor of claim 2 whereby the non-homogenous thermocatalytic gaseous reactor is an array of non-homogenous thermocatalytic gaseous reactors within a non-homogenous thermocatalytic gaseous reactor system, wherein the array of non-homogenous thermocatalytic gaseous reactors consists of at least two individual non-homogenous thermocatalytic gaseous reactors having a first non-homogenous thermocatalytic gaseous reactor and a second non-homogenous thermocatalytic gaseous reactor, whereby the first non-homogenous thermocatalytic gaseous reactor and the second non-homogenous thermocatalytic gaseous reactor are in a gaseous fluid communications when the first non-homogenous thermocatalytic gaseous reactor is in a first reactor mode and the second non-homogenous thermocatalytic gaseous reactor is in a second reactor mode, whereby the first reactor mode is different than the second reactor mode, whereby both the first reactor mode and the second reactor mode are selected from the at least two functionality modes, whereby the first non-homogenous thermocatalytic gaseous reactor is comprised of a first flow regulator of the unreacted gaseous reactant as regulated by the real-time unreacted gaseous reactant flow regulator and a first heat exchanger of the unreacted gaseous reactant, whereby the second non-homogenous thermocatalytic gaseous reactor is comprised of a second flow regulator of the unreacted gaseous reactant as regulated by the real-time unreacted gaseous reactant flow regulator and a second heat exchanger of the unreacted gaseous reactant, wherein at least one of the first flow regulator of the unreacted gaseous reactant is controlled independently from the second flow regulator of the unreacted gaseous reactant, or wherein at least one of the first heat exchanger of the unreacted gaseous reactant is controlled independently from the second heat exchanger of the unreacted gaseous reactant, and whereby the independent control of the first non-homogenous thermocatalytic gaseous reactor from the second non-homogenous thermocatalytic gaseous reactor yields a first ratio of the unreacted gaseous reactant: reacted gaseous product or reacted liquid product leaving the first non-homogenous thermocatalytic gaseous reactor that is different by at least two percent from a second ratio of the unreacted gaseous reactant: reacted gaseous product or reacted liquid product leaving the first non-homogenous thermocatalytic gaseous reactor leaving the second non-homogenous thermocatalytic gaseous reactor.

11. The non-homogenous thermocatalytic gaseous reactor of claim 10 whereby the first non-homogenous thermocatalytic gaseous reactor is in a parallel flow configuration with the second non-homogenous thermocatalytic gaseous reactor and whereby the first non-homogenous thermocatalytic gaseous reactor has an unreacted gaseous reactant bypass flow regulator upstream of the first non-homogenous thermocatalytic gaseous reactor to bypass the unreacted gaseous reactant from the first non-homogenous thermocatalytic gaseous reactor.

12. The non-homogenous thermocatalytic gaseous reactor of claim 10 whereby the first non-homogenous thermocatalytic gaseous reactor is in a series flow configuration with the second non-homogenous thermocatalytic gaseous reactor and whereby the second non-homogenous thermocatalytic gaseous reactor has an unreacted gaseous reactant bypass flow regulator upstream of the second non-homogenous thermocatalytic gaseous reactor to bypass the unreacted gaseous reactant from the second non-homogenous thermocatalytic gaseous reactor.

13. The non-homogenous thermocatalytic gaseous reactor of claim 1 is comprised of a first real-time unreacted gaseous reactant flow regulator, a second real-time unreacted gaseous reactant flow regulator, and a control system operable to vary at least one of an unreacted gaseous reactant flow direction from a forward direction by the first real-time unreacted gaseous reactant flow regulator and a back-flow direction by the second real-time unreacted gaseous reactant flow regulator within the non-homogenous thermocatalytic gaseous reactor when the non-homogenous thermocatalytic gaseous reactor is in an active catalyst mode, and wherein the real-time unreacted gaseous reactant flow regulator having the back-flow direction is closer to the interior shell of the non-homogenous thermocatalytic gaseous reactor than the real-time unreacted gaseous reactant flow regulator having the forward direction by at least 0.1 inches.

14. The non-homogenous thermocatalytic gaseous reactor of claim 13 wherein the back-flow direction having a back-flow velocity real-time flow rate that is faster than the forward direction having a forward flow velocity real-time flow rate by at least 5 percent.

15. The non-homogenous thermocatalytic gaseous reactor of claim 1 further comprised of a back-flow direction unreacted gaseous reactant stream having an initial back-flow direction unreacted gaseous reactant real-time flow rate and an initial back-flow direction unreacted gaseous reactant real-time temperature, and a forward direction unreacted gaseous reactant stream having an initial forward direction unreacted gaseous reactant real-time flow rate and an initial forward direction unreacted gaseous reactant real-time temperature, whereby the forward direction unreacted gaseous reactant stream and the back-flow direction unreacted gaseous reactant stream are both internal of an interior shell of the non-homogenous thermocatalytic gaseous reactor, whereby the back-flow direction unreacted gaseous reactant stream is at least 5 percent closer to the interior shell of the non-homogenous thermocatalytic gaseous reactor than the forward direction unreacted gaseous reactant stream, and wherein an initial back-flow velocity of the back-flow direction unreacted gaseous reactant stream is greater than an initial forward direction velocity of the forward direction unreacted gaseous reactant stream.

16. The non-homogenous thermocatalytic gaseous reactor of claim 15 whereby the initial back-flow direction unreacted gaseous reactant real-time flow rate is at least 5 percent higher than the initial forward direction unreacted gaseous reactant real-time flow rate and whereby the initial back-flow direction unreacted gaseous reactant real-time temperature is at least 5 degrees Celsius lower than the initial forward direction unreacted gaseous reactant real-time temperature.

17. The non-homogenous thermocatalytic gaseous reactor of claim 16 whereby a back-flow direction flow inlet port of the back-flow direction unreacted gaseous reactant stream enters the non-homogenous thermocatalytic gaseous reactor above by at least 1 inch higher than a forward direction flow inlet port of the forward direction unreacted gaseous reactant stream.

18. The non-homogenous thermocatalytic gaseous reactor of claim 1 further comprised of a power generation system having a power generation compressor operating as a vacuum to remove the stream of residual gases from the non-homogenous thermocatalytic gaseous reactor during a mode transition from an active catalyst mode of the non-homogenous thermocatalytic gaseous reactor to a non-reactive catalyst mode of the non-homogenous thermocatalytic gaseous reactor.

19. The non-homogenous thermocatalytic gaseous reactor of claim 1 further comprised of a power generation system having a power generation combustor operating as an external combustor to combust the stream of residual gases as a first fuel.

20. The non-homogenous thermocatalytic gaseous reactor of claim 19 further comprising a second fuel having a second fuel flow regulator, whereby the first fuel has a first fuel flow regulator, a control system to operate the first fuel flow regulator and the second fuel flow regulator, and wherein the control system varies by at least 2 percent a fuel flow ratio of the second fuel flow regulator: the first fuel flow regulator to modulate a multi-fuel emissions profile by at least 1 percent compared to a first fuel emissions profile created downstream of the external combustor.
